(19) United States
(12) Patent Application Publication
(10) Pub. No.: US 2026/0112843 A1
(43) Pub. Date: Apr. 23, 2026

(54) END USER INSTALLED POWER CORD

(71) Applicant: Lasko Operation Holdings LLC, West Chester, PA (US)

(72) Inventor: Neil Franciotti, Doylestown, PA (US)

(21) Appl. No.: 19/346,750

(22) Filed: Oct. 1, 2025

Related U.S. Application Data
(60) Provisional application No. 63/708,960, filed on Oct. 18, 2024.

(51) Int. Cl. H01R 13/627; H01R 13/645; H01R 13/688; H01R 13/713; H01R 24/30; H01R 43/26; H01R 105/00

(52) U.S. Cl. CPC H01R 13/6278; H01R 13/645; H01R 13/688; H01R 13/7135; H01R 24/30; H01R 43/26; H01R 2105/00

(57) ABSTRACT

A structure for an improved end user installed power cord is provided. The invention includes features integrated orthogonal structure which allow for greater safety and strength as well as improved end user installation.

### CROSS REFERENCE TO RELATED APPLICATIONS

This application claims priority to U.S. Provisional Patent Application Ser. No. 63/708,960, filed on Oct. 18, 2024, which is hereby incorporated by reference in its entirety.

### TECHNOLOGY FIELD

This disclosure relates to appliance power cords. More specifically, this disclosure relates to end user installed power cords and the interface relationship between an electric appliance and a power cord.

### BACKGROUND

Conventional electrical appliances require a power cord to electrically attach the appliance to a power source. Such power cords are installed at the manufacturer. Installation of the power cord at a manufacturer increases the manufacturing cost of the appliance. As a result, end user installed power cords are periodically used to mitigate such costs.

The structure of a conventional end user installed power cord has several disadvantages. The design of the conventional end user installed power cord routes the power cord in such a fashion to create a tripping and/or a safety hazard. Conventional power cord routing may also interfere with storage and other use applications of the appliance. The shape and structure of the conventional end user installed power cord can make the power cord difficult for the end user to install securely in an electrical appliance.

Also, end user installed power cords need to comply with safety and industry standards. It can be important that the design of an end user installed power cord be easy to install while at the same time include structures to comply with the safety and industrial standards as well as the ability to withstand normal use conditions. The structure of a conventional end user installed power cord often compromise either “ease of installation” or “standard compliance”or “durability”under normal use conditions.

In short what is needed is an end user installed power cord which is simple and easy to install and at the same time complies with safety and industrial standards, as well as mitigates tripping and safety hazards inherent to conventional end user installed power cords.

### SUMMARY

Described herein is an end user installed power cord for an electrical appliance which is designed for easy installation and safe use. The end user installed power cord disclosed has conductors which are orthogonal relative to the direction of installation of the power cord to the appliance. The orthogonal structure creates a large and unobstructed surface to which the end user can apply greater force to ensure secure installation when compared to the structure of conventional end user installed power cords. The described end user installed power cord has advantages for the end user and the manufacturer regarding safety because the conductors can be routed towards the ground, mitigating a tripping hazard found in conventional end user installed power cords. Also described is a locking device between the power cord and an appliance interface which easily and securely attaches the power cord to the appliance and maintains the durability required for both “normal use” and industrial standard requirements.

### BRIEF DESCRIPTION OF THE DRAWINGS

The invention is best understood from the following detailed description when read in connection with the accompanying drawing. It is emphasized that, according to customary practice, the various features of the drawing are not necessarily to scale. Included in the drawing are the following Figures:

FIG. 1 is a perspective view of an embodiment of an improved end user installed power cord;

FIG. 2 is a front view and a right-side view of an improved end user installed power cord;

FIG. 3 is an exploded view of an improved end user installed power cord;

FIG. 4 is an illustration of an application of an improved end user installed power cord;

FIGS. 5a and 5b illustrate the advantages of an improved end user installed power cord compared to a conventional end user installed power cord;

FIG. 6 is a front and a right-side view of another embodiment of an improved end user installed power cord;

FIG. 7 is a front view and a right-side view of an alternative embodiment of an improved end user installed power cord;

FIG. 8 is a cross-section view of an embodiment of an improved end user installed power cord;

FIG. 9 is a cross-section view of an alternate embodiment of an improved end user installed power cord; and

FIGS. 10a and 10b are cross-section views illustrating the assembly and locking mechanisms of an improved end user installed power cord with an appliance.

### DETAILED DESCRIPTION OF ILLUSTRATIVE EMBODIMENTS

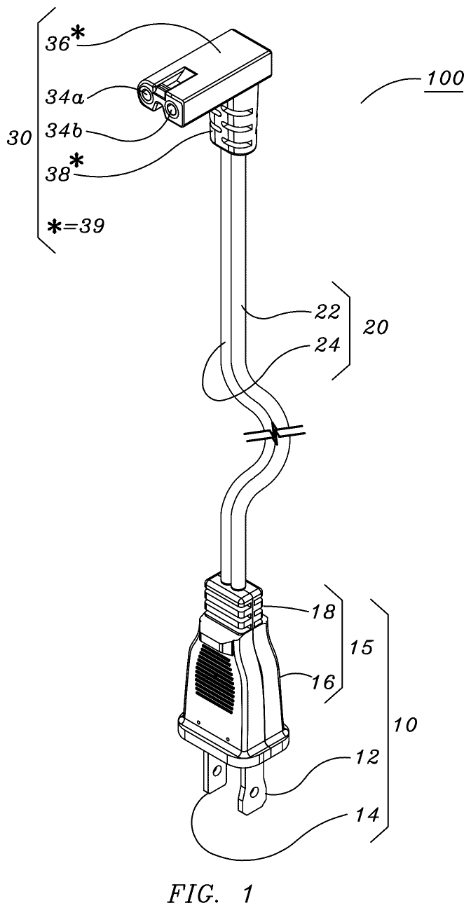

FIG. 1 is a perspective view of an embodiment of an improved end user installed power cord 100 including power source plug 10, power conductor 20, and appliance end adapter 30. Similar to conventional end user installed power cords, power cord 100 is installed by the individual who will be using the appliance. Prior to installing power cord 100 the appliance cannot be operated. After power cord 100 is installed by the end user, the appliance can be operationally connected to an electrical power source. As shown, power source plug 10 may include power connector 12, power connector 14, and housing 15. Housing 15 may include portion 16 and conductor transition portion 18. Power conductor 20 may include more than one conductor 22 and conductor 24. The length of power conductor 20 may vary depending upon the application. Appliance end adapter 30 includes connector access 34a and 34b, housing 39. Housing 39 may include portion 36 and conductor transition portion 38.

Power connectors 12/14 are shown as a blade configuration capable of interfacing with a conventional wall power receptacle. Appliance connector access 34a/34b are shown as hollow cylindrical constructions. It is contemplated that other structures and forms could be used for power connectors 12/14 and appliance connector access 34a/34b without departing from the spirit of the invention.

As shown power source plug 10 is compatible with conventional power receptacles. Power conductor 20 may be constructed of copper or other electrically conductive materials having a solid or braided construction. Power conductor 20 may include an electrically insulative material to electrically isolate the conductive materials of conductor 22 and conductor 24. The length of power conductor 20 may vary depending upon the needs and applications.

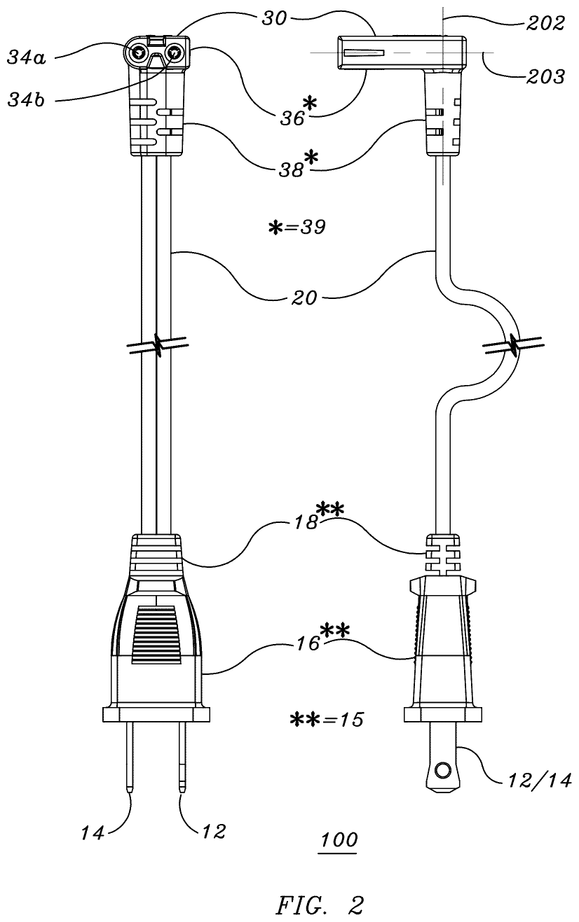

FIG. 2 is a front view and a right-side view of an improved end user installed power cord 100. As can be seen appliance interface axis B 203 is the direction of interface between appliance end adapter 30 and an appliance. Conductor 20 exits appliance end adapter 30 along conductor exit axis A 202. Conductor exit axis A 202 is not parallel or aligned with appliance interface axis B 203. As shown conductor exit axis A 202 is substantially orthogonal to appliance interface axis 203 B.

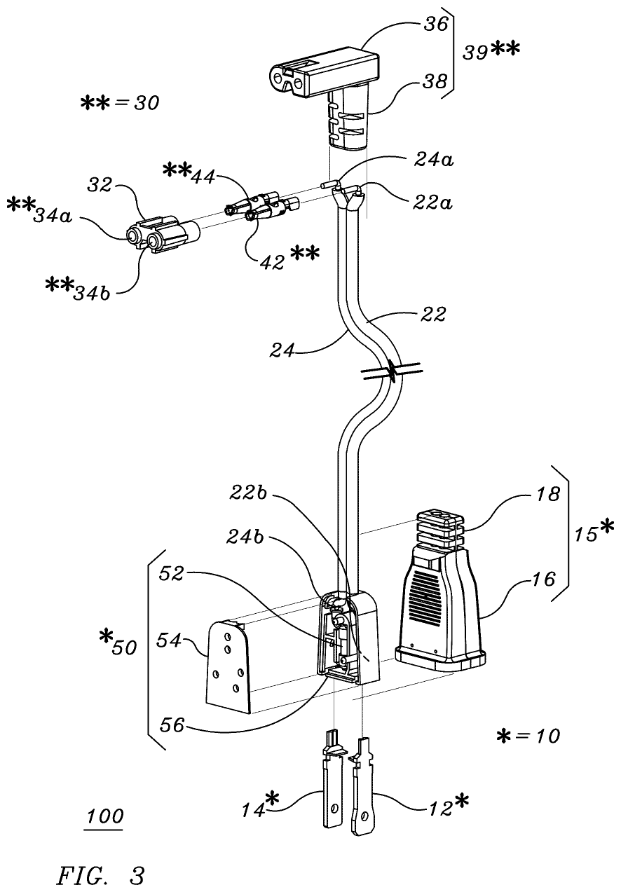

FIG. 3 is an exploded view of an improved end user installed power cord 100. Conductor 22 and conductor 24 may include ends 22a/22b and 24a/24b respectively. Ends 22a/22b and 24a/24b have been prepared to allow electrical contact with power connectors 12/14 and connectors 42/44.

Power source plug 10 may include circuit interrupter 50. Circuit interrupter 50 may include fuse 52, box 56 and cap 54. As shown, power connector 14 is electrically connected to end 24b of conductor 24 while fuse 52 of circuit interrupter 50 is in electrical connected series between power connector 12 and end 22b of conductor 22. As such fuse 52 can interrupt the flow of power from power source plug 10 to appliance end adapter 30. It is contemplated that circuit interrupter 50 may be used to interrupt the flow of power based on amperage, temperature or voltage and the like. As shown housing 15, may include portion 16 and conductor transition portion 18 and may be constructed of a polymer and at least partially molded-over power connectors 12/14, conductor 20, and circuit interrupter 50 thereby assembling these components securely in place. It is also contemplated that circuit interrupter 50 may be absent from end user installed power cord 100 and power connector 12 may be directly connected to end 22b.

Appliance end adapter 30 includes connectors 42/44 which are electrically connected to ends 22a/24a respectively of conductor 20. Connectors 42/44 interface with connector frame 32 through connector access 34a/34b. Appliance end adapter 30 also includes housing 39. Housing 39 includes portion 36 and conductor transition portion 38. Housing 39 may be made of a polymer and at least partially molded-over appliance connector frame 32, conductor 20 and connectors 42/44 thereby securely assembling these components in place.

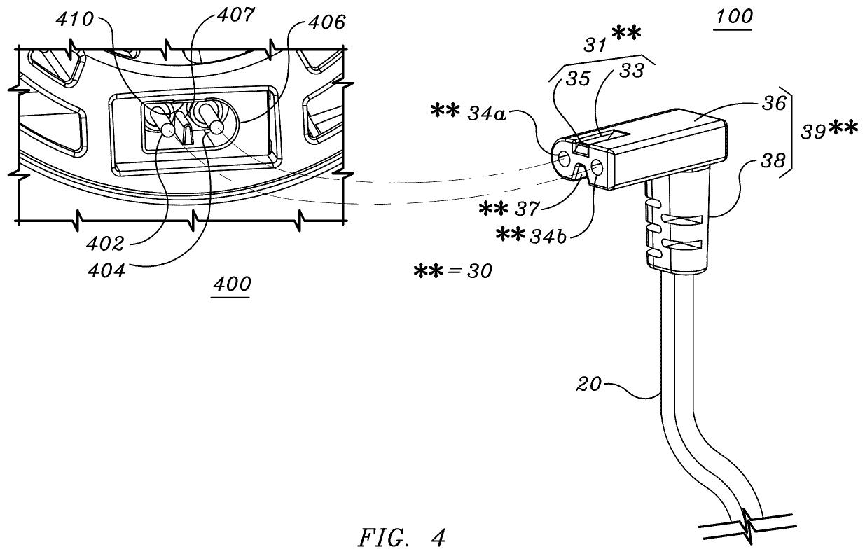

FIG. 4 is an illustration of an application of improved end user installed power cord 100. View 400 is representative of interface details of an appliance. Cavity 406 is similar in form/shape to housing 39 of end user installed power cord 100. Located in cavity 406 are pins 402/404 and alignment structure 407 and locking tab 410. When housing 39 is inserted into cavity 406 electrical connection is made between pins 402/404 and connectors 42/44 (see FIG. 3) of appliance end adapter 30. When housing 39 is inserted into cavity 406, locking tab 410 interfaces with adapter lock 31 thereby impeding the removal of appliance end adapter 30 from cavity 406. Adapter lock 31 may include retention wall 35 and recess 33. Alignment structure 407 can interface with guide channel 37 of housing 39 to assure directional stability of the assembly between appliance end adapter 30 with cavity 406.

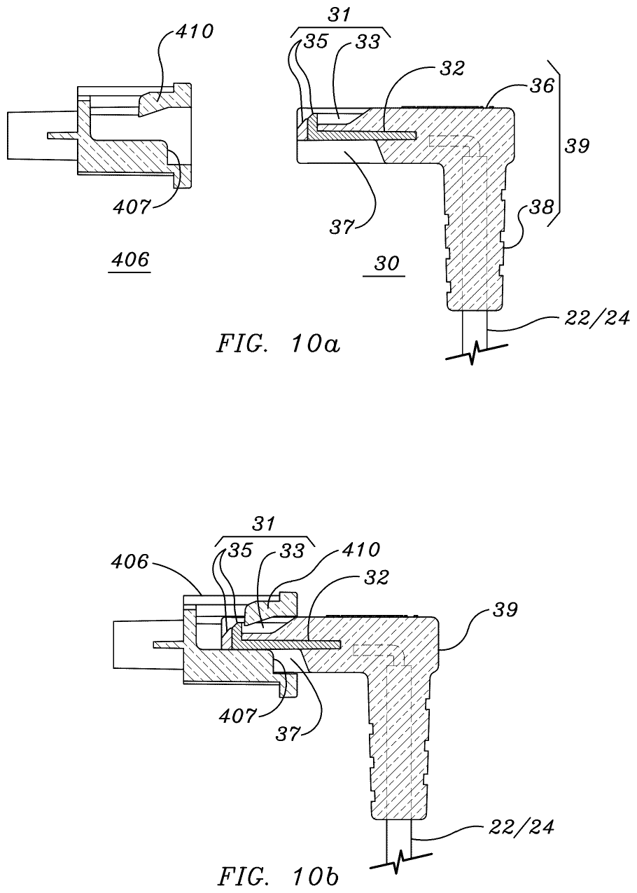

As can be seen the unique shape and form similarities between cavity 406, structures 407/410 of the appliance and housing 39, adapter lock 31, channel 37 of end user installed power cord 100 prevent the end user from using an alternate or conventional power cord. Additional information regarding these features can be seen in FIGS. 10a and 10b. These unique structures of cavity 406 of appliance and housing 39 ensure safety features such as circuit interrupter 50 which may be included in end user installed power cord 100 will be used with the appliance (see FIG. 3), ensuring the designed safety features of the appliance are always used which is important for both the end user and the manufacturer.

As shown connector access 34a/34b, connectors 42/44 and, pins 402/404 are of a corresponding shape to allow a mechanical and electrical connection between these features. The cylindrical shape of connector access 34a/34b, connectors 42/44 and, pins 402/404 does not limit the invention. It is contemplated that the shape and structure of connector access 34a/34b, connectors 42/44 and, pins 402/404 could be flat, triangular or other shapes without departing from the spirit of the invention.

As shown connector access 34a/34b, connectors 42/44 are hollow cylindrical receptacles while pins 402/404 are cylindrical pins. It is contemplated connector access 34a/34b, connectors 42/44 could be incorporated into an appliance while pins 402/404 could be incorporated into appliance end adapter 30, effectively reversing the illustrated structure without departing from the spirit of the invention.

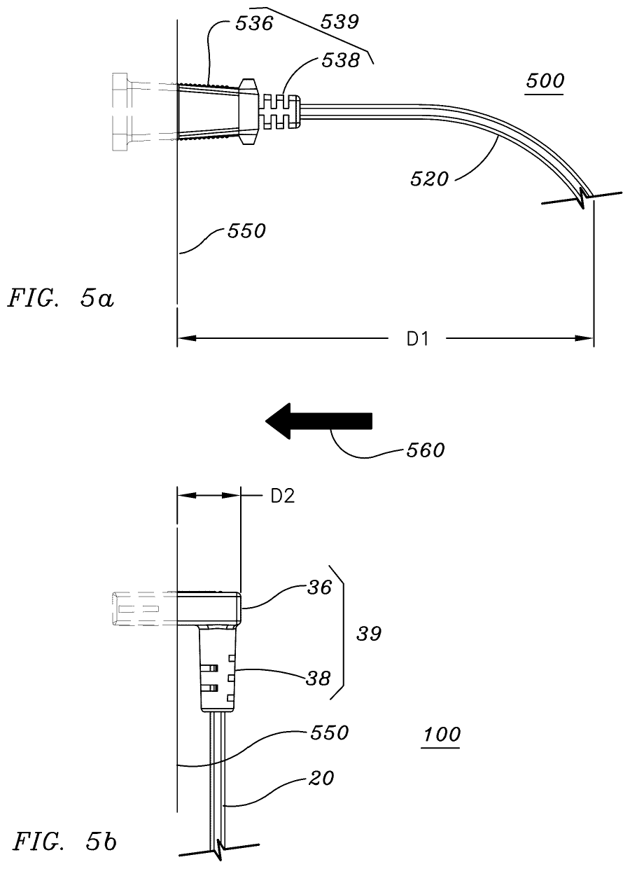

FIGS. 5a and 5b illustrate some of the advantages of improved end user installed power cord 100 compared to conventional end user installed power cord 500. As per FIG. 5a when conventional end user installed power cord 500 is assembled to appliance 550, the aligned structure of portion 536, conductor transition portion 538 of housing 539, and conductor 520 define a distance D1 of the natural arc of conductor 520. FIG. 5b shows improved end user installed power cord 100 assembled to appliance 550, the non-aligned orthogonal structure of portion 36, conductor transition portion 38 of housing 39 and conductor 20 define a distance D2 of the designed path of conductor 20. Also shown is arrow 560 indicating the direction of movement for end user installation of power cords 100/500.

As can be appreciated distance D2 is less than distance D1 which allows the path of conductor 20 to be directed by design proximate to appliance 550. The location of conductor 20 relative to appliance 550 mitigates of a tripping/safety hazard, particularly if appliance 550 is used in a high foot traffic area. Such appliances may be a “consumer appliances” which can be used in a home, such as portable fans, portable heaters and portable air cleaners. Distance D1 allows end user installed power cord 100 to avoid interference with other objects such as screens and the like. For example, if appliance 550 is a fan and is located in a window to move air in or out of a room.

End user installed power cord 100 has an additional advantage compared to conventional end user installed power cord 500. The end user has unobstructed access to apply a unidirectional force during the assembly of power cord 100 to appliance 550. Housing 39 allows the end user the unobstructed application of force in the direction of arrow 560, unlike end user installed power cord 500 which has an aligned structure of housing 539 and conductor 520 requiring the end user to use multiple force components to install housing 536 to appliance 550, (i.e. pinching housing 539 with fingers while simultaneously exserting force in the direction of arrow 560). The need to use multiple force components increases the difficulty for the und user to properly assemble housing 536 to appliance 550 when compared to the assembly of housing 39 with appliance 550.

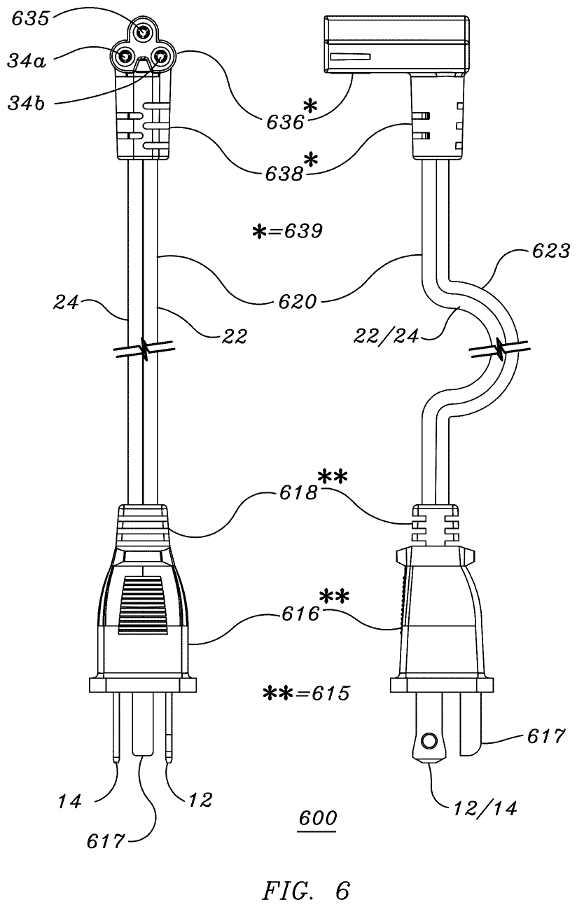

FIG. 6 is a front and a right-side view of another embodiment of an improved end user installed power cord 600. End user installed power cord 600 includes additional power connector 617 protruding from housing 615. Housing 615 includes portion 616 and conductor transition portion 618. End user installed power cord 600 also includes additional conductor 623 as part of power conductor 620. Housing 639 includes portion 636 and conductor transition portion 638 and additional appliance connector access 635. The additional electrical connection between power connector 617, conductor 623 and connector access 635 may represent a grounding circuit. It is contemplated that additional electrical circuits can be included without departing from the spirit of the invention.

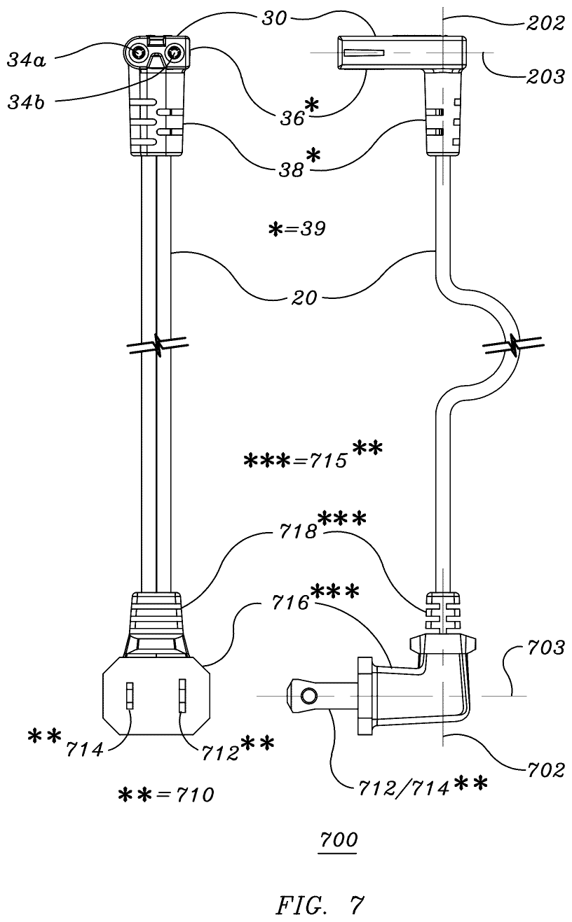

FIG. 7 is a front view and a right-side view of an alternative embodiment of an improved end user installed power cord 700. As can be seen, similar to improved end user installed power cord 100 of FIG. 2 appliance interface axis B 203 is the direction of interface between appliance end adapter 30 and an appliance conductor 20 exits appliance end adapter 30 along conductor exit axis A 202. Conductor exit axis A 202 is not parallel or aligned with appliance interface axis B 203. As shown conductor exit axis A 202 is substantially orthogonal to appliance interface axis B 203.

As shown, power source plug 710 may include power connector 712, power connector 714, housing 715. Housing 715 includes portion 716 and conductor transition portion 718. Power interface axis D 703 is the direction of the interface between power source plug 710 and a power source. Conductor 20 exits power source plug 710 along conductor exit axis C 702. Conductor exit axis C 702 is not parallel or aligned with power interface axis D 703. As shown, conductor exit axis C 702 is substantially orthogonal to power interface axis D 703. This structure permits similar use advantages between power source plug 710 and a power source as those advantages described for the appliance connection in association with FIG. 5b.

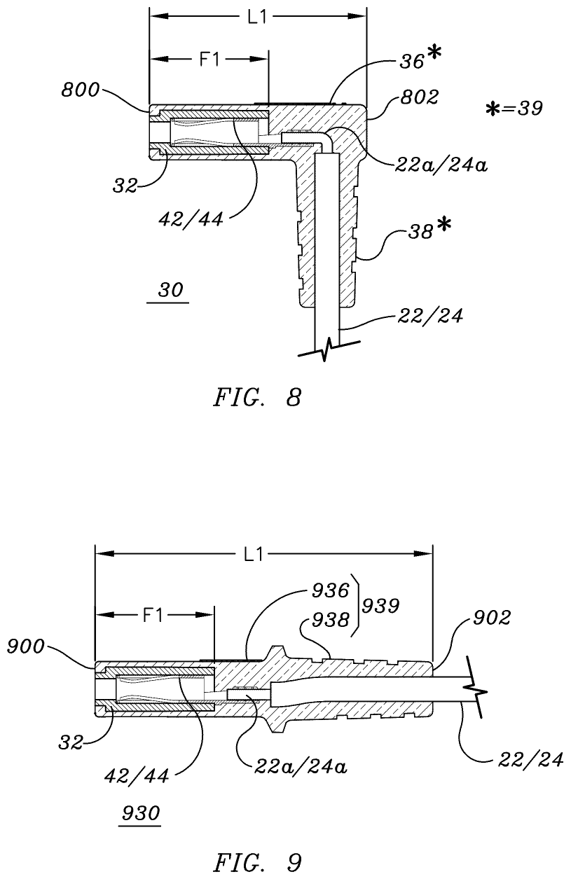

FIG. 8 is a cross-section view of appliance end adapter 30. Internal to housing 39 are connectors 42/44 located in connector frame 32 and ends 22a/24a of conductors 22/24 are mechanically and electrically assembled to connectors 42/44. Connector frame 32 may be constructed of PBT (Polybutylene Terephthalate) and housing 39 may be an injection molded PVC (Polyvinyl Chloride). PBT has high thermal resistance and is a relatively ridged thermoset polymer. PVC has a lower thermal resistance and is a relatively flexible polymer.

Interface surface 800 is the lead face of housing 39 which interfaces with an appliance. Extent 802 is the farthest extent of housing 39 opposite interface surface 802. Length dimension L1 is defined by a linear dimension measured from interface surface 800 to extent 802. Also shown, length dimension F1 is defined by a linear dimension measured from interface surface 802 to an opposite extent of connector frame 32. Length dimension F1 is substantially parallel to length dimension L1.

It has been found that limiting dimension F1 in relation to dimension L1 increases the structural stability of appliance end adapter 30 under operational conditions and industry standard testing requirements. In one embodiment dimension F1 is 60% or less compared to dimension L1. This ratio enhances the structural flex of appliance end adapter 30 to mitigate breakage when normal operational conditions and standard testing requirements forces are exerted on the structures of appliance end adapter 30.

FIG. 9 is a cross-section view of appliance end adapter 930. Appliance end adapter 930 includes housing 939. Housing 939 includes portion 936 and conductor transition portion 938. As can be seen portion 936 and conductor transition portion 938 are substantially aligned when compared to housing 39 of FIG. 8 Internal to housing 939 are connectors 42/44 located in connector frame 32 and ends 22a/24a of conductors 22/24 are mechanically and electrically assembled to connectors 42/44. Connector frame 32 may be constructed of PBT (Polybutylene Terephthalate) and housing 39 may be an injection molded PVC (Polyvinyl Chloride). PBT has high thermal resistance and is a relatively ridged thermoset polymer. PVC has a lower thermal resistance and is a relatively flexible polymer.

Interface surface 900 is the lead face of housing 939 which interfaces with an appliance. Extent 902 is the farthest extent of housing 939 opposite interface surface 802. Length dimension L1 is defined by a linear dimension measured from interface surface 900 to extent 902. Also shown is length dimension F1 which is defined by a linear dimension measured from interface surface 900 to an opposite extent of connector frame 32. Length dimension F1 is substantially parallel to length dimension L1.

It has been found that limiting dimension F1 in relation to dimension L1 increases the structural stability of appliance end adapter 930 under operational conditions and industry standard testing requirements. In one embodiment dimension F1 is 60% or less compared to dimension L1. This ratio enhances the structural flex of appliance end adapter 930 to mitigate breakage when normal operational conditions and standard testing requirements forces are exerted on the structures of appliance end adapter 930.

FIGS. 10a and 10b are cross-section views illustrating the assembly and locking of appliance end adapter 30 with cavity 406 of an appliance. FIG. 10a illustrates appliance end adapter 30 including adapter lock 31. Adapter lock 31 includes retention wall 35 and recess 33 located proximate retention wall 35. As shown, retention wall 35 is partially composed of a portion of connector frame 32 and housing portion 36. Utilizing part of the structure of connector frame 32 as part of retention wall 35 augments the structural strength and rigidity of retention wall 35, effectually increasing the structural strength and integrity of the assembly between appliance end adapter 30 with cavity 406 of an appliance.

Cavity 406 may include alignment structure 407 and locking tab 410. Alignment structure 407 interfaces with guide channel 37 to align adapter lock 31 with locking tab 410 to securely assemble end adapter 30 with cavity 406.

FIG. 10b illustrates the assembly of adapter 30 with cavity 406. When adapter 30 and cavity 406 are fully engaged locking tab 410 will move over retention wall 35 and return to its original position into recess 33 thereby securely assembling end adapter 30 with cavity 406 of an appliance. As can be appreciated the structural strength of retention wall 35 can be important to maintaining a secure assembly between end adapter 30 with cavity 406. In some embodiments, the assembly of end adapter 30 with cavity 406 may be a permanent assembly, meaning disassembly after the initial assembly will cause permanent damage to components and prevent continued use. The inability to use the appliance caused by the permanent damage as mentioned, prevents the use of an alternate power cord with the appliance. Preventing the use of an alternate power cord ensures that safety devices, such as circuit interrupter 50 will be in the circuit thereby maintaining the integrated safety feature.

Although the invention has been described with reference to exemplary embodiments, it is not limited thereto. Rather the information should be construed to include other variants and embodiments of the invention, which may be made by those skilled in the art without departing from the true spirit and scope of the present invention.

What is claimed:

1. A power cord comprising:
at least two parallel conductors electrically insulated from each other comprising:
a first end of said two conductors;
a second end of said two conductors;
a power source plug attached to said first end of said two conductors comprising;
a first housing connected to said first end of said conductors;
a first power connector disposed in said first housing and electrically connected to said first end of one of said two conductors;
a second power connector disposed in said first housing and electrically connected to said first end of the other of said two conductors;
an appliance adapter attached to said second end of said two conductors comprising;
a second housing connected to said second end of said conductors, said second housing comprising;
a conductor transition portion;
a length dimension L1 defined by a linear dimension measured from an interface surface to an opposite extent of said second housing;
a connector frame disposed in said second housing comprising;
a length dimension F1 defined by a linear dimension measured from said interface surface to an opposite extent of said connector frame, said dimension F1 being parallel to dimension L1;
a first appliance connector supported by said connector frame and disposed in said second housing and electrically connected to said second end of one of said two conductors;
a second appliance connector supported by said connector frame and disposed in said second housing and electrically connected to said second end of the other of said two conductors; and
wherein said power source plug mechanically and electrically connects to a power supply and said appliance adapter mechanically and electrically connects to an appliance.

2. The power cord of claim 1 wherein said dimension F1 has a ratio which is equal to or less than 65% of dimension L1 and said ratio equal to or less than 65% allows said second housing to withstand stress forces absent breakage as compared to a ratio greater than 65%.

3. The power cord of claim 2 further comprising a mechanical lock to prevent a removal of said appliance adapter from said appliance after said mechanical connection is made between said appliance adapter and said appliance.

4. The power cord of claim 3 wherein said mechanical lock comprises:
a first feature located on said appliance adapter; and
a second feature located on said appliance;
wherein said first feature and said second feature interface to prevent said removal of said appliance adapter from said appliance.

5. The power cord of claim 4 wherein said first feature includes a recess and a retention wall integrated into said appliance adapter and said second feature comprises a locking tab and said mechanical connection of said appliance adapter and said appliance comprises said locking tab located within said recess wherein said retention wall impedes a removal of said appliance adapter from said appliance and said retention wall is at least partially composed of a portion of said connector frame.

6. The power cord of claim 1 wherein said second housing is an L-shaped housing comprising:
an axis A defined by the direction in which said second end of said two conductors enter said second housing passing through said conductor transition portion; and
an axis B substantially orthogonal to axis A and substantially parallel to dimension L1 which further defines a direction of interface between said second housing and said appliance.

7. The power cord of claim 1 wherein said appliance is a consumer appliance and said power cord is an end user installed power cord connected to said appliance by said end user and not by the appliance manufacturer.

8. The power cord of claim 1 further comprising a mechanical lock to prevent a removal of said appliance adapter from said appliance after said mechanical connection is made between said appliance adapter and said appliance.

9. The power cord of claim 8 wherein said mechanical lock comprises:
a first feature located on said appliance adapter; and
a second feature located on said appliance;
wherein said first feature and said second feature interface to prevent said removal of said appliance adapter from said appliance.

10. The power cord of claim 9 wherein said first feature includes a recess and a retention wall integrated into said appliance adapter and said second feature comprises a locking tab and said mechanical connection of said appliance adapter and said appliance comprises said locking tab located within said recess wherein said retention wall impedes a removal of said appliance adapter from said appliance.

11. The power cord of claim 1 further comprises a grounding circuit comprising;
a third conductor parallel to said first and second conductors electrically insulated from said first and second conductors wherein said third conductor comprises;
a first end of said third conductors;
a second end of said third conductors;
a third power connector disposed in said first housing and electrically connected to said first end of said third conductor;
a third appliance connector disposed in said second housing supported by said connector frame and electrically connected to said second end of said third conductor; and
wherein said grounding circuit electrically connects said power supply to said appliance.

12. The power cord of claim 1 further comprising a circuit interrupter disposed within said first housing and coupled between and electrically connecting said first power connector to said first end of one of said conductors, wherein said circuit interrupter interrupts electric flow based on a pre-determined amperage level.

13. The power cord of claim 12 wherein said circuit interrupter is a single use fuse.

14. The power cord of claim 12 wherein said circuit interrupter is a multi-use resettable circuit interrupter.

15. A method to reduce a tripping/safety hazard of an end user installed power cord as it exits an appliance comprising:
an appliance adapter including an L-shaped appliance adapter housing attached to at least two parallel electrical conductors, said parallel conductors being electrically insulated from each other;
appliance connectors disposed in said appliance adapter housing and electrically connected to said two parallel conductors;
a conductor entry axis A aligned and parallel with said conductors entering said appliance adapter housing;
a connector axis B aligned and parallel with said appliance connectors in said appliance adapter housing and substantially orthogonal to said axis A; and
an operational configuration of said appliance defined by said appliance adapter being assembled to said appliance;
wherein said orthogonal orientation of axis A and axis B reduces a distance of said conductors from said appliance in said operational configuration and mitigates possible tripping/safety hazard to a user of said appliance.

16. The method of claim 15 wherein said appliance is a consumer appliance and said appliance adapter is mechanically and electrically connected to said appliance by said end user of said appliance and not by the appliance manufacturer.

17. The method of claim 15 including a mechanical lock to prevent a removal of said appliance adapter from said appliance after said appliance is in said operational configuration.

18. The method of claim 17 wherein said mechanical lock includes;
a first feature located on said appliance adapter; and
a second feature located on said appliance;
wherein said first feature and said second feature interface to prevent said removal of said appliance adapter from said appliance.

19. The method of claim 18 wherein said first feature includes a recess and a retention wall integrated into said appliance adapter; and said second feature comprises a locking tab and said prevention of said removal of said appliance adapter from said appliance comprises said locking tab located within said recess wherein said retention wall impedes a removal of said appliance adapter from said appliance.

20. The method of claim 15 including a connector frame disposed in said appliance adapter housing and supporting said appliance connectors.

21. The method of claim 20 including;
a length dimension L1 defined by a linear dimension measured from an appliance interface surface to an opposite extent of said second housing;
a length dimension F1 defined by a linear dimension measured from said interface surface to an opposite extent of said connector frame, said dimension F1 being parallel to dimension L1; and
a ratio of said dimension F1 compared to said dimension L1 wherein dimension F1 is equal to or less than 65% of dimension L1.

22. The method of claim 21 wherein said ratio of equal to or less than 65% allows said second housing to withstand stress forces absent breakage as compared to a ratio greater than 65%.

23. The method of claim 21 including a mechanical lock to prevent a removal of said appliance adapter from said appliance after said appliance is in said operational configuration.

24. The method of claim 23 wherein said mechanical lock comprises:
a first feature located on said appliance adapter; and
a second feature located on said appliance;
wherein said first feature and said second feature interface to prevent said removal of said appliance adapter from said appliance.

25. The method of claim 24 wherein said first feature includes a recess and a retention wall integrated into said appliance adapter; and said second feature comprises a locking tab and said prevention of said removal of said appliance adapter from said appliance comprises said locking tab located within said recess wherein said retention wall impedes a removal of said appliance adapter from said appliance and wherein said retention wall is at least partially composed of a portion of said connector frame.
